(19) United States
(12) Patent Application Publication
(10) Pub. No.: US 2018/0022559 A1
(43) Pub. Date: Jan. 25, 2018

(54) Loader Positioning System

(71) Applicant: Scott William Knutson, Crookston, MN (US)

(72) Inventor: Scott William Knutson, Crookston, MN (US)

(21) Appl. No.: 15/216,942

(22) Filed: Jul. 22, 2016

(51) Int. Cl. B65G 67/22; A01B 69/00; B65G 67/24; G08G 1/0962; G08G 1/133

(52) U.S. Cl. CPC B65G 67/22; G08G 1/09626; G08G 1/133; B65G 67/24; A01B 69/007

(57) ABSTRACT

A loader positioning system which includes a positional sensor and visual indicators for centering a product being loaded from a loading vehicle into a receiving vehicle. The loader positioning system generally includes a loading vehicle including a dispenser for dispensing a material and a container for receiving the material. A sensor on the loading vehicle detects a distance between the loading vehicle and the container. A control unit receives and processes the positional data from the sensor and compares it to optimal spacing between the loading vehicle and the container such that the dispenser is centrally positioned over the container for central loading of the material into the container. A display in the loading vehicle provides movement instructions to an operator of the loading vehicle such that the dispenser is centrally positioned over the container for optimal loading of the material into the container.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a loader positioning system which includes a positional sensor and visual indicators for centering a product being loaded from a loading vehicle into a receiving vehicle.

### Related Art

Any discussion of the related art throughout the specification should in no way be considered as an admission that such related art is widely known or forms part of common general knowledge in the field.

In various industries such as agriculture, it is necessary to transfer a load of material such as dirt or crops from one vehicle to another. The materials are generally harvested by a loading vehicle and transferred via a dispenser from the loading vehicle to a receiving vehicle or container. Very often, it is most efficient to transfer such materials from the loading vehicle to the receiving vehicle while both of the vehicles are in motion. When loading the materials while on-the-move, it is difficult to manually maintain optimal spacing between the loading vehicle and the receiving vehicle or container to ensure center loading of the materials into the receiving vehicle or container.

Failure to optimally dispense the materials from the loading vehicle to the receiving vehicle can result in poor weight distribution in the loaded container. Previous systems for maintaining such spacing between the two vehicles have utilized either fixed dispensers which are connected between the two vehicles or flags or the like which hang from one of the vehicles at a distance to provide a visual indication of proper spacing.

### SUMMARY

An example embodiment of the present invention is directed to a loader positioning system. The loader positioning system includes a loading vehicle including a dispenser for dispensing a material and a container for receiving the material. A sensor on the loading vehicle detects a distance between the loading vehicle and the container. A control unit receives and processes the positional data from the sensor and compares it to optimal spacing between the loading vehicle and the container such that the dispenser is centrally positioned over the container for central loading of the material into the container. A display in the loading vehicle provides movement instructions to an operator of the loading vehicle such that the dispenser is centrally positioned over the container for optimal loading of the material into the container.

There has thus been outlined, rather broadly, some of the features of the loader positioning system in order that the detailed description thereof may be better understood, and in order that the present contribution to the art may be better appreciated. There are additional features of the loader positioning system that will be described hereinafter and that will form the subject matter of the claims appended hereto. In this respect, before explaining at least one embodiment of the loader positioning system in detail, it is to be understood that the loader positioning system is not limited in its application to the details of construction or to the arrangements of the components set forth in the following description or illustrated in the drawings. The loader positioning system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a frontal view of a loader positioning system in accordance with an example embodiment wherein spacing is too far.

FIG. 2 is a frontal view of a loader positioning system in accordance with an example embodiment wherein spacing is too close.

FIG. 3 is a frontal view of a loader positioning system in accordance with an example embodiment with optimal spacing.

FIG. 4 is a block diagram of a loader positioning system in accordance with an example embodiment.

FIG. 5 is a flowchart illustrating usage of a loader positioning system in accordance with an example embodiment.

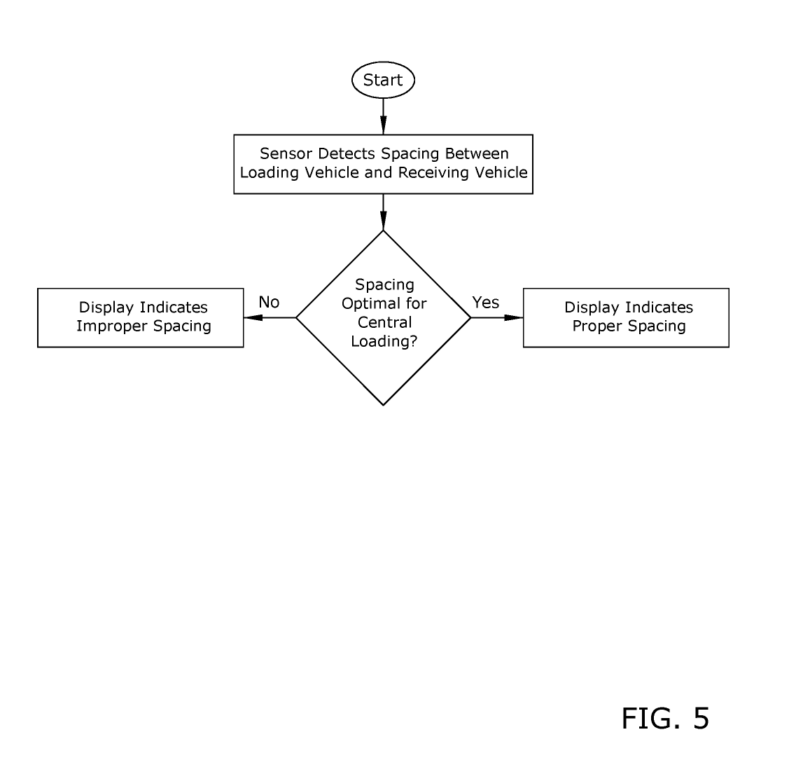

FIG. 6 is a flowchart illustrating usage of a loader positioning system in accordance with an example embodiment.

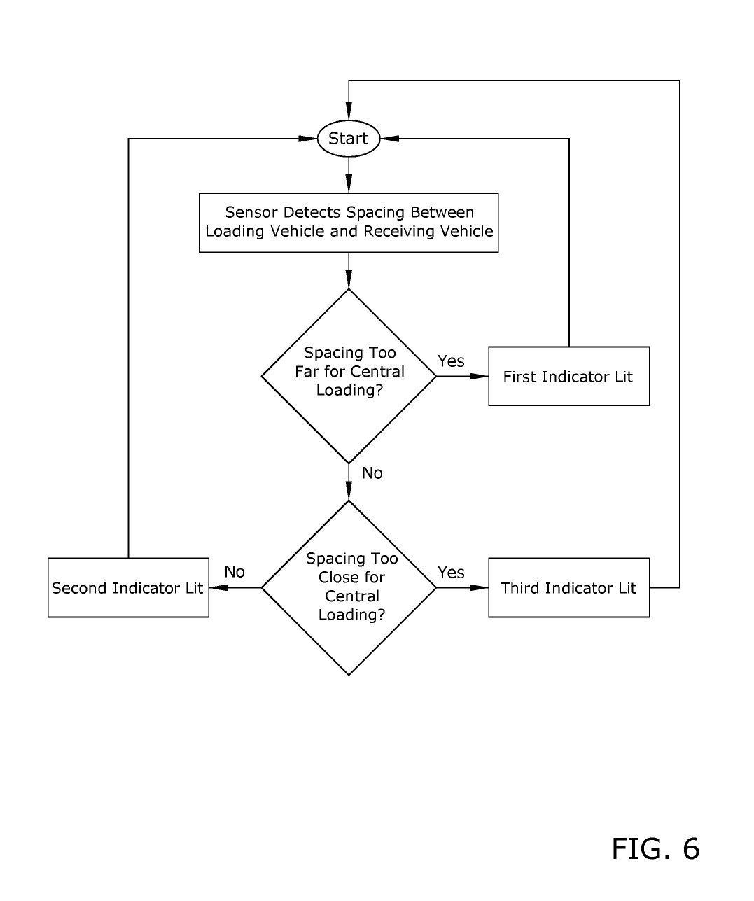

### DETAILED DESCRIPTION

### A. Overview.

An example loader positioning system generally comprises a loading vehicle 12 including a dispenser 13 for dispensing a material and a container 16 for receiving the material. A sensor 40 on the loading vehicle 12 detects a distance between the loading vehicle 12 and the container 16. A control unit 20 receives and processes the positional data from the sensor 40 and compares it to optimal spacing between the loading vehicle 12 and the container 16 such that the dispenser 13 is centrally positioned over the container 16 for central loading of the material into the container 16. A display 31 in the loading vehicle 12 provides movement instructions to an operator of the loading vehicle 12 such that the dispenser 13 is centrally positioned over the container 16 for optimal loading of the material into the container 16.

In another embodiment, the loading vehicle 12 dispenses material into a container 16 on a receiving vehicle 15. In such an embodiment, the receiving vehicle 15 is generally adjusted with respect to the loading vehicle 12. A display 30, 31, which may be positioned on the loading vehicle 12, the receiving vehicle 15 or both, provides movement instructions to an operator of the receiving vehicle 15 such that the dispenser 13 is centrally positioned over the container 16 for optimal loading of the material into the container 16.

The exemplary figures illustrate the methods and systems described herein being utilized in connection with a loading vehicle 12 and a receiving vehicle 15. It should be appreciated that various configurations of loading vehicles 12 and receiving vehicles 15 may be supported by the methods and systems described herein. The methods and systems described herein may be applied to numerous industries and various types of materials being loaded, including without limitation crops, dirt, mined materials, debris, and the like.

Any system which utilizes loading of materials from a loading vehicle 12 to a receiving vehicle 15 or container 16 may benefit from the methods and systems described herein for optimally loading the receiving vehicle 15 or container 16 for proper weight distribution. In some embodiments, the receiving vehicle 15 or container 16 may be stationary and thus, it is not a requirement that both vehicles 12, 15 be in motion. In most cases, the loading vehicle 12 is on a set path (such as when harvesting crops or removing ground materials for a road), so the receiving vehicle 15 will be adjusted with respect to the loading vehicle 12 to obtain central loading of the container 16. In other embodiments, the loading vehicle 12 may be adjusted with respect to the receiving vehicle 15.

The loading vehicle 12 is generally the vehicle which retrieves the materials being loaded into the receiving vehicle 15 or container 16. An exemplary loading vehicle 12 would be a crop harvester which continuously harvests crops it passes over and transfers the harvested crops via a dispenser 13 such as a chute into a container 16. The loading vehicle 12 may include a towed or pushed implement which itself retrieves and distributes the materials.

The receiving vehicle 15 may include a container 16 into which the materials are dispensed from the dispenser 13 of the loading vehicle 12. The dispenser 13 will generally be positioned above the container 16 so that the materials are distributed via a gravity to fall into the container 16. Proper positioning of the dispenser 13 over the center of the container 16 will accomplish optimal loading for weight distribution and the like.

The container 16 may be towed, pushed, or integral with the receiving vehicle 15. In some embodiments, a discrete receiving vehicle 15 may be omitted, with the materials being dispensed directly into a stationary container 16. The methods and systems described herein would be equally advantageous for use with both containers 16 in motion and stationary containers 16.

### B. Control Unit.

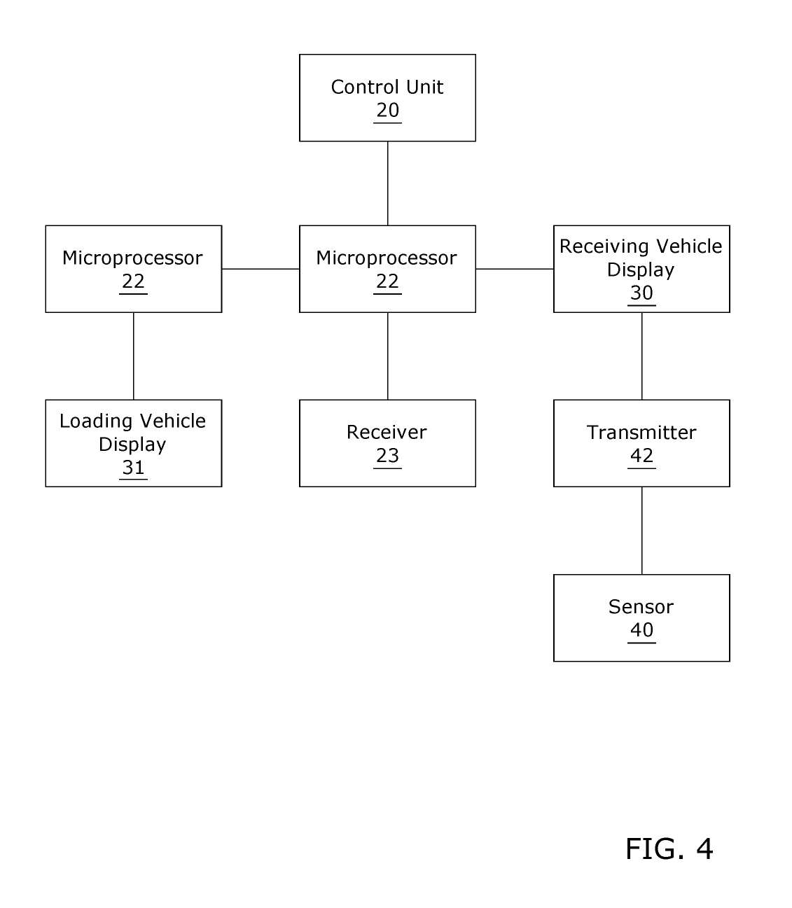

FIG. 4 illustrates an exemplary block diagram of an exemplary embodiment of the loader positioning system 10. As shown, the methods and systems described herein will generally utilize a control unit 20 which receives and processes data from the sensor 40. The control unit 20 may comprise a computer, integrated circuitry, circuitry, or the like which is programmed or designed to perform the various functions described herein, such as receiving and processing data.

The control unit 20 may comprise a microprocessor 22 which performs the various functionalities described herein. The control unit 20 will generally include a receiver 23 for receiving data and signals from the sensor 40. The control unit 20 is communicatively interconnected with the sensor 40, such as by wires or wireless connection.

The microprocessor 22 will continuously process data from the sensor 40 to determine whether the loading vehicle 12 and receiving vehicle 15 or container 16 are optimally spaced from each other such that the dispenser 13 is centrally positioned over the receiving vehicle 15 or container 16 for optimal loading.

The microprocessor 22 and control unit 20 may be communicatively interconnected with operator controls. The operator controls allow the operator to control the spacing of the loading vehicle 12 with respect to the container 16 when the loading vehicle 12 is in motion. In other embodiments, the operator controls allow the operator to control the spacing the receiving vehicle 15 with respect to the loading vehicle 12.

In some embodiments, automatic adjustments may be made to the operator controls by the control unit 20 to automatically move the loading vehicle 12 for optimal spacing. In other embodiments, a display 30, 31 including indicators 32, 33, 34 for optimal spacing may be utilized to allow an operator of the loading vehicle 12 or the receiving vehicle 15 to manually adjust spacing in response to instructions from the control unit 20.

### C. Display.

As shown in the figures, a loader display 31 is generally provided in the loading vehicle 12 to provide a visual indication of optimal spacing to the operator of the loading vehicle 12. The configuration and nature of the loader display 31 may vary in different embodiments. The loader display 31 could be integrated with the control unit 20, such as in embodiments in which the control unit 20 is a computer, or may be separate. The loader display 31 may be integrated with the dashboard or other interior components of the loading vehicle 12.

A remote receiver display 30 may be positioned in or on the receiving vehicle 15 to provide instructions to the operator of the receiving vehicle 15 to maneuver the receiving vehicle 15 for optimal spacing with respect to the loading vehicle 12. The remote receiver display 30 may be communicatively interconnected with the control unit 20 to receive instructions therefrom.

The display 30, 31 will direct movement of the loading vehicle 12 to provide for optimal positioning with respect to the container 16 or direct movement of the receiving vehicle 15 with respect to the loading vehicle 12. The display 30, 31 may include one or more indicators 32, 33, 34 which direct positioning of the loading vehicle 12 for optimal dispensing. The figures and descriptions herein should not be construed as limiting in any manner on the number or type of indicators 32, 33, 34 utilized, as any visual indication of how to maneuver the loading vehicle 12 to provide optimal spacing and thus center loading from the dispenser 13 may be utilized.

In some embodiments, audio indicators may be provided instead or in addition to visual indicators 32, 33, 34. For example, a voice could direct movement of the loading vehicle 12 without any visual indication. The audio indicators could also be used in addition to the visual indicators 32, 33, 34 to ensure that the operator fully understands how to maneuver the loading vehicle 12.

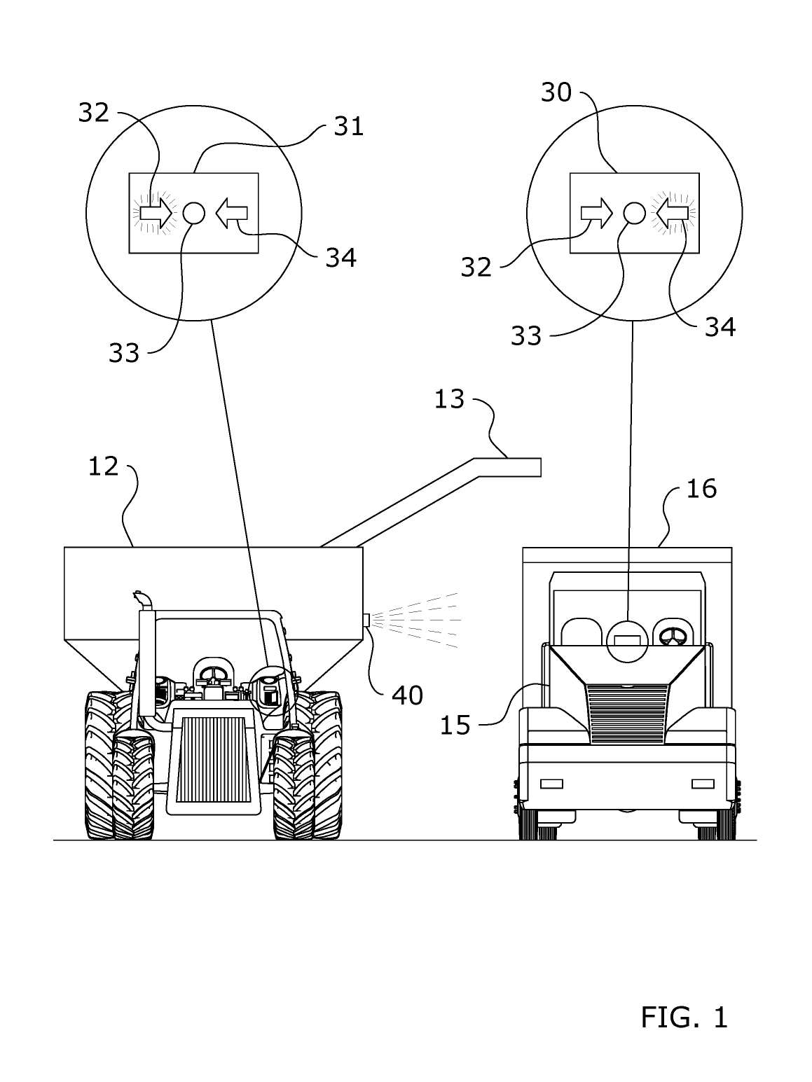

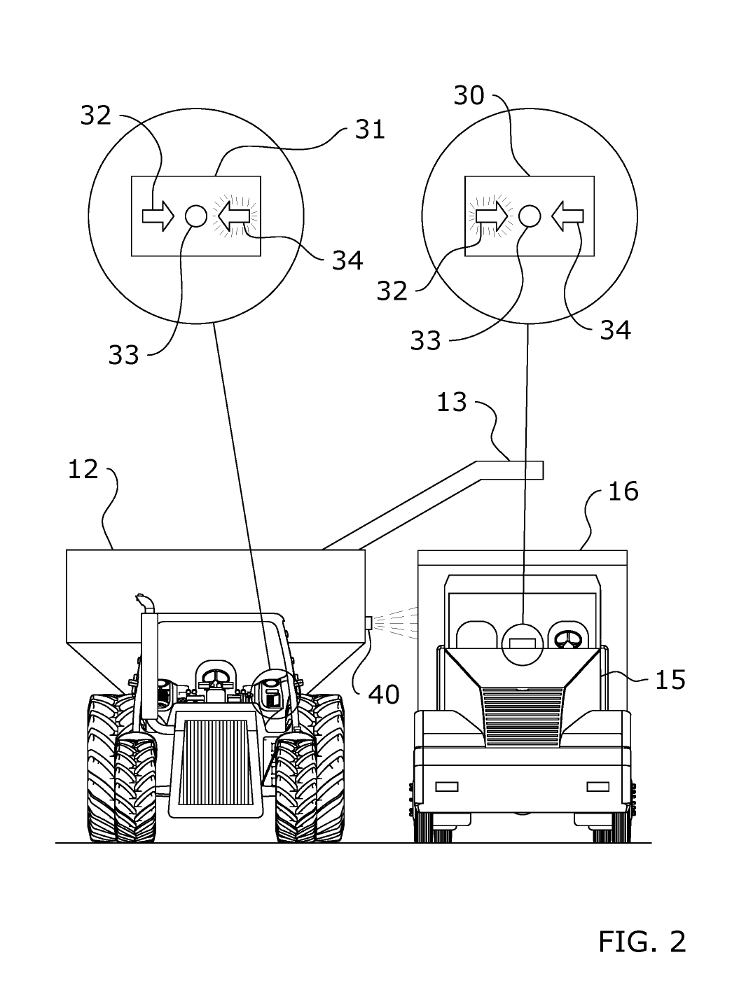

By way of example and without any limitation, FIGS. 1 and 2 provide exemplary indicators 32, 33, 34 on a display 30, 31 to provide for optimal spacing between the loading vehicle 12 and the receiving vehicle 15. As shown, a first indicator 32 comprises a first arrow, a second indicator 33 comprises a central circle, and a third indicator 34 comprises a second arrow. The first and second indicators 32, 34 direct movement of the receiving vehicle 15 in a certain direction.

For example, the first indicator 32, comprising an arrow pointing at the second indicator 33 in a first direction, will be lit up when the receiving vehicle 15 should be moved in the first direction for optimal spacing. The third indicator 34, comprising an arrow pointing at the second indicator 33 in a second direction, will be lit up when the receiving vehicle 15 should be moved in the second direction for optimal spacing. The second indicator 33 lights up when optimal spacing has been achieved.

### D. Sensor.

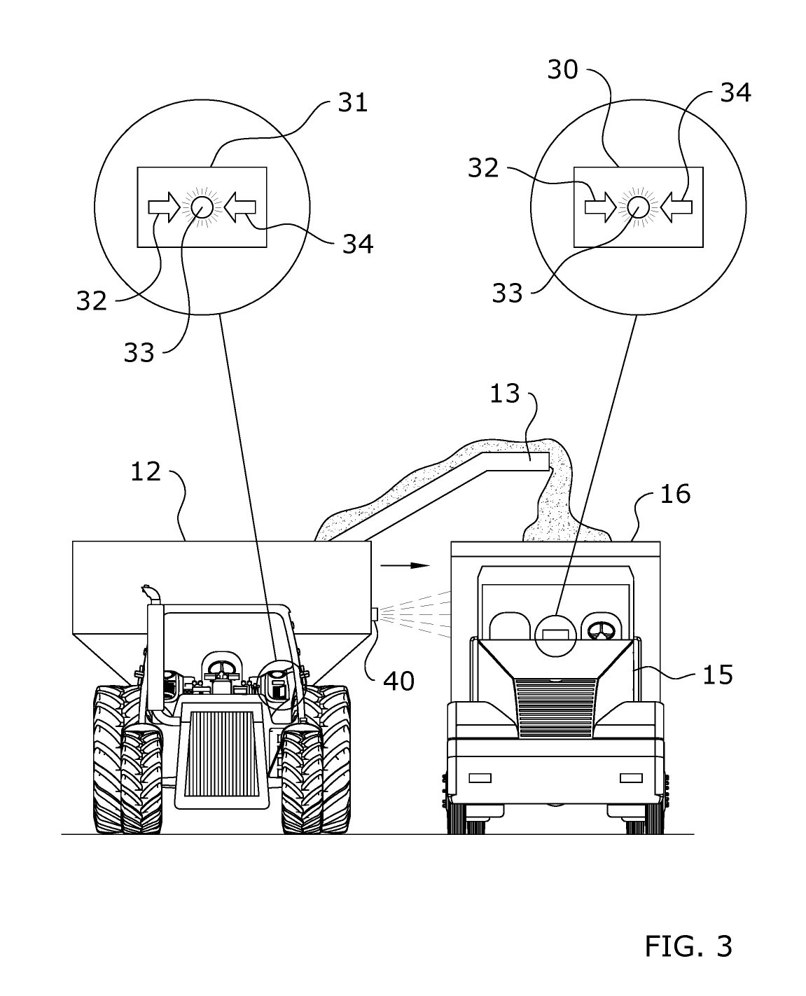

As shown in FIG. 3, a sensor 40 is provided for detecting the distance between the loading vehicle 12 and the receiving vehicle 15 or container 16. Various types of sensors 40 may be utilized so long as the sensor 40 is capable of detecting the distance between the loading vehicle 12 and the receiving vehicle 15 or container 16.

The sensor 40 will generally detect the distance between the loading vehicle 12 and the receiving vehicle 15 or container 16; with this data being communicated to the control unit 20 for processing. The sensor 40 is thus generally positioned on the loading vehicle 12 in the direction of where the receiving vehicle 15 will be positioned. In some embodiments, a pair of sensors 40 may be utilized; with one sensor 40 on either side of the loading vehicle 12 to accommodate different loading scenarios.

The sensor 40 is communicatively interconnected with the control unit 20 so that the control unit 20 may continuously receive positional data as it relates to the distance between the loading vehicle 12 and the receiving vehicle 15 or container 16. The sensor 40 may be hardwired to the control unit 20 or may be wirelessly connected. A transmitter 42 may thus be provided to transmit data from the sensor 40 to the receiver 23 of the control unit 20 in real-time.

An exemplary type of sensor 40 for use with the methods and systems described herein is a sonar sensor 40 which uses filtered sonar to read the distance between the loading vehicle 12 and the receiving vehicle 15 or container 16. A sonar signal is periodically or continuously transmitted outwardly from the sensor 40 to detect the distance between the loading vehicle 12 and the receiving vehicle 15 or container 16. Data from the sensor 40 is transmitted to the control unit 20 for processing.

Alternatively, a laser sensor 40 may be utilized. In such an embodiment, the sensor 40 may emit a laser outwardly toward the receiving vehicle 15 or container 16. The laser will detect the distance between the loading vehicle 12 and the receiving vehicle 15 or container 16; with the data being transmitted to the control unit 20 for processing.

### E. Operation of Preferred Embodiment.

The methods and systems described herein may be utilized with receiving vehicles 15 in motion or containers 16 which are not in motion. In either case, the sensor 40 will detect the distance between the receiving vehicle 15 or container 16 and the loading vehicle 12. The control unit 20 receives and processes the positional data from the sensor 40 to provide instructions via one or both displays 30, 31 to maintain optimal spacing between the loading vehicle 12 and the container 16 or the loading vehicle 12 and the receiving vehicle 15.

In the case where both the loading vehicle 12 and the receiving vehicle 15 or container 16 are in motion, the loading vehicle 12 and the receiving vehicle 15 will move in parallel with each other so that the dispenser 13 is always over the container 16. As the vehicles 12, 15 are in motion, the loading vehicle 12 will continuously retrieve materials, such as by scooping dirt or harvesting crops, which are dispensed out of the dispenser 13 and into the container 16.

In the case where the receiving vehicle 15 or container 16 is stationary, the loading vehicle 12 will first approach the receiving vehicle 15 or container 16. The sensor 40 will detect the spacing there between as the loading vehicle 12 is moved into position to allow for optimal spacing as discussed below.

The sensor 40 will continuously detect the distance between the loading vehicle 12 and the receiving vehicle 15 or container 16. When the distance is too far apart, the display 30, 31 will indicate so, such as by lighting up the first indicator 32 which instructs the operator to move the loading vehicle 12 toward the container 16 or instructs the operator to move the receiving vehicle 15 toward the loading vehicle 12. When the distance is too close, the display 30, 31 will indicate so, such as by lighting up the third indicator 34 which instructs the operator to move the loading vehicle 12 away from the container 16.

When the distance is optimal, the display 30, 31 will indicate so, such as by lighting up the second indicator 33. This will indicate to the operator that the distance between the loading vehicle 12 and receiving vehicle 15 is optimized such that the dispenser 13 is centrally positioned over the receiving vehicle 15 or container 16 so that the materials are centrally loaded into the receiving vehicle 15 or container 16.

It should be appreciated that the display 30, 31 may be positioned on the loading vehicle 12, the receiving vehicle 15, or both. The displays 30, 31 may vary depending on the perspective of the individual making the adjustments. For example, a loader display 30 may show arrows in a first direction toward the receiving vehicle 15 while the receiver display 31 may show arrows in a second direction toward the loading vehicle 12 when the loading and receiving vehicle 15 need to be closer to each other.

Unless otherwise defined, all technical and scientific terms used herein have the same meaning as commonly understood by one of ordinary skill in the art to which this invention belongs. Although methods and materials similar to or equivalent to those described herein can be used in the practice or testing of the loader positioning system, suitable methods and materials are described above. All publications, patent applications, patents, and other references mentioned herein are incorporated by reference in their entirety to the extent allowed by applicable law and regulations. The loader positioning system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A loader positioning system, comprising:
a loading vehicle including a dispenser for dispensing a material;
a container for receiving the material;
a sensor for detecting a distance between the loading vehicle and the container;
a controller for receiving positional data from the sensor; and
a display for providing movement instructions to an operator of the loading vehicle such that the dispenser is centrally positioned over the container for optimal loading of the material into the container.

2. The loader positioning system of claim 1, wherein the sensor comprises a sonar sensor adapted to continuously or periodically transmit a sonar signal from the loading vehicle toward the container.

3. The loader positioning system of claim 1, wherein the sensor comprises a laser sensor adapted to continuously or periodically transmit a laser from the loading vehicle toward the container.

4. The loader positioning system of claim 1, wherein the display comprises a first arrow indicating that the loading vehicle should be moved in a first direction for optimal spacing and a second arrow for indicating that the loading vehicle should be moved in a second direction for optimal spacing.

5. The loader positioning system of claim 4, wherein the display comprises a visual indicator that the loading vehicle is an optimal distance from the container.

6. The loader positioning system of claim 1, further comprising a receiving vehicle, wherein the container is connected to the receiving vehicle.

7. The loader positioning system of claim 1, wherein the material comprises harvested crops.

8. The loader positioning system of claim 1, wherein the control unit is connected to a receiver for receiving positional data from the sensor.

9. The loader positioning system of claim 8, wherein the sensor is connected to a transmitter for transmitting positional data from the sensor.

10. The loader positioning system of claim 1, wherein the control unit comprises a microprocessor.

11. A loader positioning system, comprising:
a loading vehicle including a dispenser for dispensing a material;
a receiving vehicle including a container for receiving the material;
a sensor for detecting a distance between the loading vehicle and the container;
a controller for receiving positional data from the sensor; and
a display for providing movement instructions to an operator of the receiving vehicle such that the dispenser is centrally positioned over the container of the receiving vehicle for optimal loading of the material into the container.

12. The loader positioning system of claim 11, wherein the sensor comprises a sonar sensor adapted to continuously or periodically transmit a sonar signal from the loading vehicle toward the container.

13. The loader positioning system of claim 11, wherein the sensor comprises a laser sensor adapted to continuously or periodically transmit a laser from the loading vehicle toward the container.

14. The loader positioning system of claim 11, wherein the display comprises a first arrow indicating that the loading vehicle should be moved in a first direction for optimal spacing and a second arrow for indicating that the loading vehicle should be moved in a second direction for optimal spacing.

15. The loader positioning system of claim 14, wherein the display comprises a visual indicator that the loading vehicle is an optimal distance from the container.

16. The loader positioning system of claim 11, wherein the display is on the receiving vehicle.

17. The loader positioning system of claim 1, wherein the material comprises harvested crops.

18. The loader positioning system of claim 1, wherein the control unit is connected to a receiver for receiving positional data from the sensor.

19. The loader positioning system of claim 8, wherein the sensor is connected to a transmitter for transmitting positional data from the sensor.

20. The loader positioning system of claim 1, wherein the control unit comprises a microprocessor.
